(19) United States
(12) Patent Application Publication
(10) Pub. No.: US 2014/0019915 A1
(43) Pub. Date: Jan. 16, 2014

(54) DATA STORAGE AND RETRIEVAL SYSTEM

(71) Applicant: Stephen Livermore, Hertfordshire (GB)

(72) Inventor: Stephen Livermore, Hertfordshire (GB)

(73) Assignee: FORTRUS LIMITED, Hertfordshire (GB)

(21) Appl. No.: 14/002,887

(22) PCT Filed: Mar. 13, 2012
(86) PCT No.: PCT/GB2012/050548

§ 371 Date: Sep. 27, 2013

(30) Foreign Application Priority Data
Mar. 16, 2011 (GB) 1104427.8

(51) Int. Cl. G06F 3/0484

(52) U.S. Cl. CPC G06F 3/04842
USPC 715/838

(57) ABSTRACT

A data retrieval system is disclosed comprising means for displaying data relating to one or more entities in a timeline format wherein the data is presented to a user by an icon on a display related with a particular point on a timeline whereby a user can take an action in relation to an icon and view or otherwise process or manipulate further data or a document related to the data represented by the icon.

This invention relates to a data storage and retrieval system. In particular, but not exclusively, it relates to a system for storing records relating to individuals or other entities. A typical example is for a patient records system in a healthcare environment and in such an environment many different types of pieces of data have to be stored for a particular patient, which can extend over a period of time, and includes consultation records, records relating to medical tests and procedures; records relating to inpatient stays, social and/or psychiatric reports and many other types of data, in addition to basic bibliographic data regarding the patient. In a healthcare environment, it may be necessary to view any of many different types of data at any time and to be able to view them at different locations (such as at a general practitioners surgery, at a hospital, at an outpatient clinic, probably even at the patient's own home) it can also be important to see the chronology and timescale of events.

Similar considerations apply in other fields such as the legal field, for example a patent attorney's office where a patent attorney needs to keep records relating to clients and the progress of client's patent, trade mark or other intellectual property applications, including many types of data such as patent specifications, copies of notes, records of past and upcoming deadlines, general correspondence and others, all of which may need to be accessed, perhaps at several different locations.

Data can be referred to as structured or unstructured data. Structured data may involve objects that can be represented by short symbol strings and numbers (such as test results obtained over a period of time or other types of data, and unstructured data may be data that does not reside in fixed locations, such as word processing documents, pdf files, email messages, images, videos and so on.

It is difficult with previously proposed data storage and retrieval systems to properly accommodate both types of data and to be able to retrieve them at will and in a manner which takes into their chronology.

According to the present invention there is provided a data retrieval system, comprising means for displaying data relating to one or more entities in a timeline format wherein the data is presented to a user by an icon on a display related with a particular point on a timeline whereby a user can take an action in relation to an icon and view or otherwise process or manipulate further data or a document related to the data represented by the icon.

The invention further provides a data retrieval system comprising means for receiving data relating to one or more entities, said data including temporal information, and means for presenting the data in a timeline format such that a user presented with the data can view the data represented by a graphical timeline, wherein a user can take action in relation to an icon and view, process and/or manipulate the data related to the icon in response to said action.

The data preferably comprises structured and unstructured data. It may be, for example, documents (such as word processor documents, image documents (eg pdf, etc) spreadsheets, image files, video files, audio files, populated or unpopulated forms, notes, or any other data.

The system may further comprise a server means adapted to receive input data from one or more devices provided locally or on a network [such as a LAN or the Internet], and to provide the aggregated, timeline, data to one or more local or network devices, which output devices have displays or can output the timeline data to display.

At least some of the temporal information will generally be date-based. It may alternatively or in addition at least some of the keyword information means be time-based.

The action may be clicking on, floating a cursor on or in the vicinity of the icon (eg within a predetermined distance thereof) or otherwise.

The click on or floating may be by a mouse or other pointing device or means be achieved by touching a touch-screen device, either the display itself or a touch device. A combination of mouse/other pointer and screen touches may be used.

Taking the action may cause an image or document, or a thumbnail, to be displayed, printed, emailed or otherwise and/or a preset option menu giving the user a plurality of choices of actions.

This system may includes an aggregator for aggregating disparate types of data, preferably including structured and unstructured data and capable of presenting the data to a user.

Icons may have different characteristics to represent different types of data. For example, they may distinguished by colour, size, shape, different indicia, markings or wording, may be arranged to flash or have different brightness, may be associated with different sounds (eg when a cursor is floated over) or otherwise.

In some embodiments, where an action is taken in relation to an icon, it may behave differently or instigate different behaviour or action according to the type of data represented by the icon.

Embodiments of the invention will now be described, by way of example only, with reference to the accompanying drawings, in which:

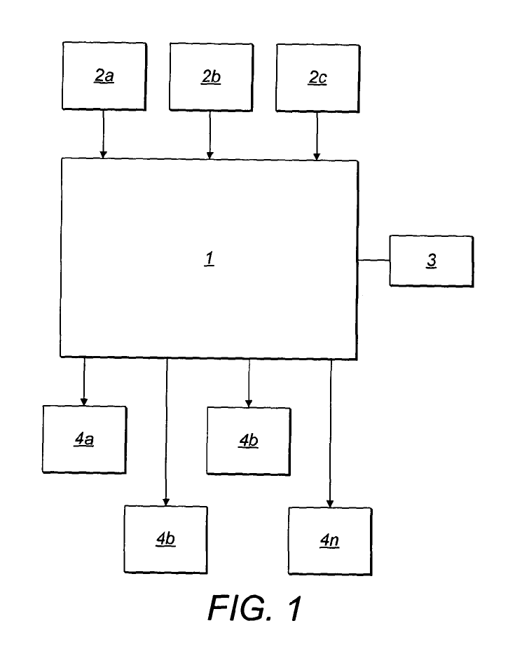

FIG. 1 shows schematic a data storage and retrieval system;

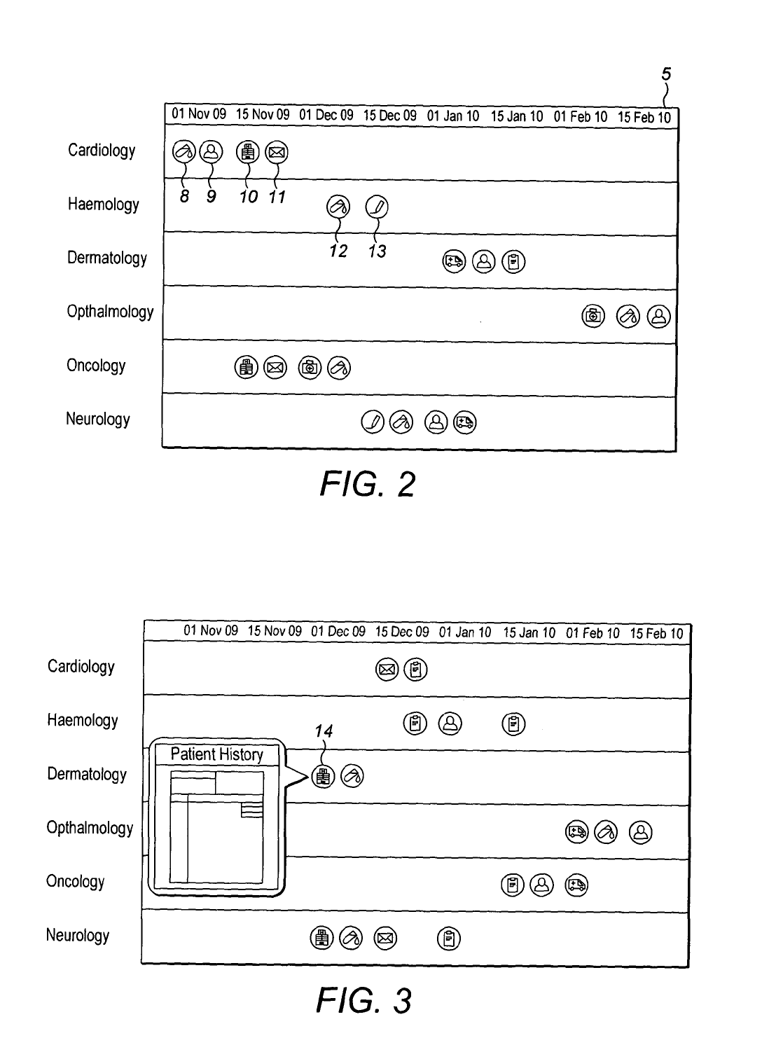

FIG. 2 shows a screen display related to a patient's medical record;

FIG. 3 shows a further screen display;

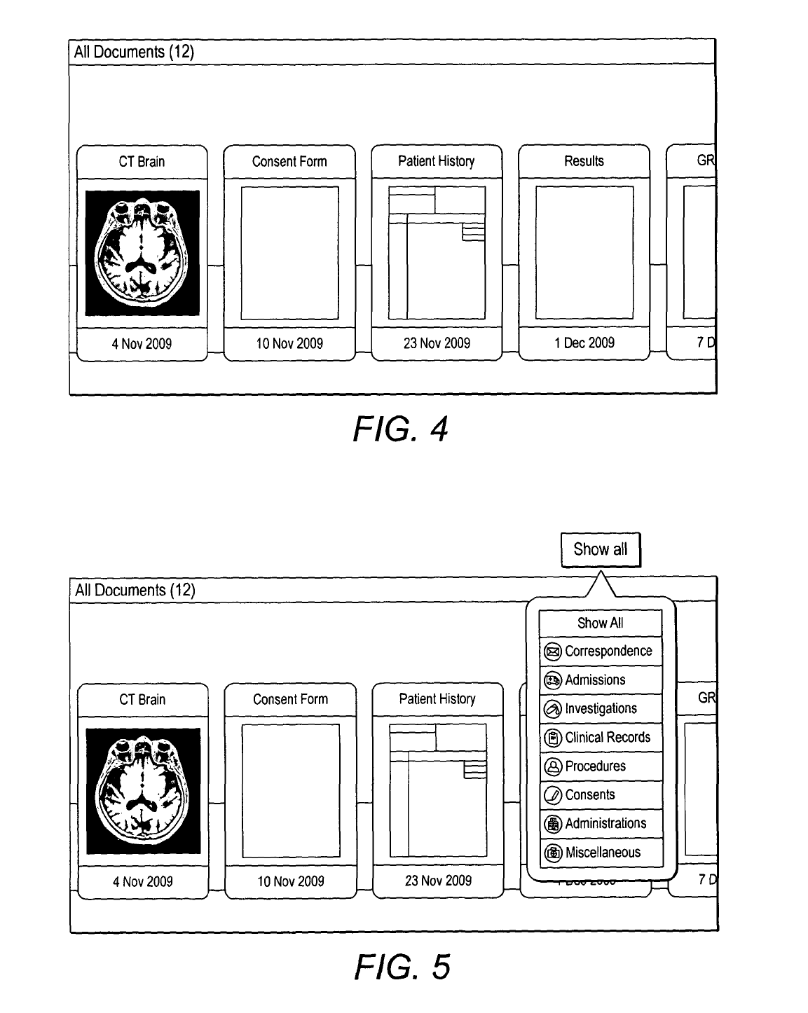

FIG. 4 shows a number of particular documents related to the patient; and

FIG. 5 shows a selection screen.

Embodiments of the invention may relate to a wide variety of document retrieval and storage systems. For example, these may be patient records in a medical environment, business records relating to companies, individuals, case records in a legal office, such as a patent attorney's office, and many other environments.

FIG. 1 shows schematically a data storage and retrieval system. Data is stored in a server 1 which includes data storage capacity (such as one more hard disks) and may of course be provided anywhere on a network, such as in any convenient location over the Internet. Of course, instead of being a single server this may comprise a number of servers which mirror/duplicate each other or which will store different parts of the data. Data can be entered into this system from a plurality of data input devices 2ₐ, 2_{b}, . . . 2ₙ. These may comprise, for example, computers, laptop computers, tablet devices such as Apple iPad™ or other devices. In a medical environment, the information may be any kind of information about a patient, including, initially, basic bibliographic data and information. Once a patient's basic details have been input via an input device 2ₐ to 2ₙ to the data stored on the server 1 then at any subsequent time in the future, further data can be added. This might be in the form of records of consultations, notes (which may be entered in a word processor format such as Microsoft Word, or as a pdf document, an XML document or any other type of structured or unstructured document. It may alternatively be test results, perhaps an image of an X-ray, an NMR or CT scan for example and/or notes related to that image or tabulated test results (eg itemised blood test results, or others). It can of course be many other types of data.

The data is arranged by the server. It is entered in such a way that its data (or other temporal data) can be accessed. This can either be done by entering it onto a system which requires a specific entry in a date field, or by using a system which determines the date of entry and automatically allocates the relevant date to that item of data. In some embodiments, a data field may be captured. This may be done by entering the data in a spreadsheet or database format and filling out a date in date field, as is known in the art. If the data is a document, the system may automatically enter the date of input. This may be done with other types of data as well.

Either at the server, or another location, the data may be indexed.

Associated with the server 1 is a document store 3. This may of course be part of the server itself or may be a separate store (or plurality of stores) connected to the server over the network such as the Internet and which can store the documents such as word processor documents, pdf documents, image files, video files or any other types of information.

The input devices may therefore be terminals or in general practitioners, (GP's) surgeries, or terminals at hospital or clinics, various types of mobile devices with medical practitioners or administrators may use or other devices. Instead of terminals this may be desktop or portable devices of any kind, or other devices.

The data stored by the server 1 may be displayed and accessed via a plurality of display devices 4ₐ to 4ₙ. Note that by the term ‘display devices’ is meant a device which is capable of displaying the information either directly (on a screen on the device itself) or a device which can be attached to a separate screen or alternative or additionally to a printer or other device. These may again be computers, laptop computers or any type of mobile device and may even be a television. Note that an input device may also be a television or similar device.

The display device may be the same device as the input device or a separate device. The display device may be a touch screen computer, tablet (eg iPad™), mobile telephone or other in which case user action is done by touching, sliding, etc of fingers or pointers on the screen.

In embodiments, data related to a particular entity (the entity may be an individual, a business, corporate entity, charity or a particular case (eg legal ‘case’, such as a patent application) or collection of data) is displayed in many different formats. Since date information is collected, one of these formats is a timeline display and a schematic example of this is shown in FIG. 2. This represents records of a particular patient relating to various tests and different medical disciplines that the patient has undergone over a period of time.

Thus, the figure shows a timeline 5 on its horizontal axis and a series of different medical disciplines such as cardiology, haematology, dermatology, ophthalmology, oncology and neurology on its vertical axis. Each particular discrete item of data, whether it be a document, an image, a set of notes, a report or any other item is indicated, on the timeline by an icon such as 8, 9, 10 or 11.

The icons are distinguished by having a different image, shape, size, colour, associated sound or any other distinguishing indicia to indicate different types of data.

Thus, one icon may represent a word processed document, another may represent a pdf document, another may represent a set of test results, another an image (from a CT or X-ray scan for example), another a referral letter and so on.

In the example given, there are four initial sets or items of data relating to cardiology on 1 and 15 Nov. 2009. The first of these 8 may relate to a set of contemporaneous notes made by a cardiologist, second item 9 (which is different) may relate an image, third icon 10 (dated 1 Nov. 2009) may relate to a letter written by the cardiologist to the patient's general practitioner, a third icon 10 (dated 15 Nov. 2009) may be a further scan, icon 11 may be a set of test results, and so on. On 15 Dec. 2009 the patient saw a haematology specialist and two different types of data 12 and 13 were entered on the system. The system also shows, for example, that there is items of data related to oncology where entered on 15 Nov. and 1 Dec. 2009 and that a series of documents related to neurology were entered on 15 Dec. 2009 and 1 Jan. 2010. Thus the viewer of the data can easily see a timeline representing each particular item of data.

The icons are clickable icons and therefore, when these are viewed on a suitable screen, if a user clicks on any of these icons (or in some embodiments may alternatively or additionally simply float a cursor above the icon, or within a certain distance or number of pixels) further detail is available. This may simply indicate the type of document, date, author, and so on or may, as shown in FIG. 3, show a thumbnail image of the actual document. In this case, when an icon 14 relating to dermatology on 15 Nov. 2009 is clicked a thumbnail image of patient's history generated at that time is displayed. Most preferably, by further clicking on the icon and/or on the thumbnail image a full screen image of the history may be viewed, printed, emailed, saved locally or otherwise or any other actions may be taken upon this document.

Instead of clicking, a touch type operation may be performed on a touch screen device.

Since the display terminals or devices 4a to 4n may be located anywhere on the Internet and receive the data from the central server (or collection of servers 1) at any stage a person needing to know details of this patient may access the data and view the data in a timeline configuration as shown. Thus, a very powerful data and document storage and retrieval system is obtained. Of course, a user at the display devices may also be enabled to enter data at that device which therefore becomes an input device as well.

In practice, of course, only a part of the entire timeline is shown in the figures and by scrolling further parts, both horizontally and vertically where appropriate, may be revealed.

FIG. 4 shows a screen in which a number of the patient's records have been selected. This may be done by selecting just the records relating to a particular discipline (such as cardiology) or all documents may be shown. In this case, a series of documents is shown in a generally thumbnail configuration with several documents shown on one screen and by clicking on a single one of these documents this can be displayed in full screen, emailed, printed, etc.

FIG. 5 shows a series of part of a further screen in which a user can choose which particular types of documents to see. He may choose to see all documents, simply just correspondence, hospital or clinic admissions, investigation, clinical records, various procedures, consents, administrations and any miscellaneous document.

Any of these types of information, or others, may be stored in the system and different icons, bearing different indicia, colour, shape, typographic images, etc may be used to distinguish between these.

1. A data retrieval system, comprising means for displaying data relating to one or more entities in a timeline format wherein the data is presented to a user by an icon on a display related with a particular point on a timeline whereby a user can take an action in relation to an icon and view or otherwise process or manipulate further data or a document related to the data represented by the icon.

2. A data retrieval system as claimed in claim 1, comprising means for receiving data relating to one or more entities, said data including temporal information, and means for presenting the data in a timeline format such that a user presented with the data can view the data represented by a graphical timeline, wherein a user can take action in relation to an icon and view, process and/or manipulate the data related to the icon in response to said action.

3. A data retrieval system as claimed in claim 1, wherein the data comprises structured and unstructured data.

4. A data retrieval system as claimed in claim 1, wherein the data comprises one or more of documents, spreadsheets, image files, video files, audio files, populated forms, unpopulated forms and notes.

5. A data retrieval system as claimed in claim 1, comprising a server means adapted to receive input data from one or more devices provided locally or on a network, and to provide aggregated, timeline, data to one or more local or network devices, which output devices have displays or can output the timeline data to one or more displays.

6. A data retrieval system as claimed in claim 2, wherein at least some of the temporal information is data-based.

7. A data retrieval system as claimed in claim 2, wherein at least some of the temporal information is time-based.

8. A data retrieval system as claimed in claim 1, wherein the user's action comprises touching, clicking on, or floating a cursor on or in the vicinity of the icon.

9. A data retrieval system as claimed in claim 8, wherein the vicinity of the icon is defined as being within a predetermined distance thereof

10. A data retrieval system as claimed in claim 1, including an aggregator for aggregating different types of data.

11. A data retrieval system as claimed in claim 1, adapted to display icons having different characteristics representing different types of data.

12. A data retrieval system as claimed in claim 11, wherein the icons are distinguished by anyone or more of colour, size, shape, indicia, marking, wording, intensity, brightness, flashing or pulsing characteristics.

13. A data retrieval system as claimed in claim 1, wherein an icon, when an action is taken in relation to it, behaves differently or instigates different behaviour or actions according to the type of data represented by the icon.

14. A data retrieval system as claimed in claim 13, wherein different sounds and/or visual effects are generated by user action in relation to icons representing different types of data.

15. (canceled)
